(19) United States
(12) Patent Application Publication
(10) Pub. No.: US 2023/0383162 A1
(43) Pub. Date: Nov. 30, 2023

(54) HEAT CONDUCTOR

(71) Applicant: SHINKO ELECTRIC INDUSTRIES CO., LTD., Nagano (JP)

(72) Inventor: Takamasa NAGASAWA, Nagano (JP)

(21) Appl. No.: 18/321,198

(22) Filed: May 22, 2023

(30) Foreign Application Priority Data
May 27, 2022 (JP) 2022-086985

(51) Int. Cl. C09K 5/14

(52) U.S. Cl. CPC C09K 5/14

(57) ABSTRACT

A heat conductor includes a first resin layer and a second resin layer each free of a filler, multiple carbon nanotubes extending between the first resin layer and the second resin layer, a first heat transfer layer, and a second heat transfer layer. The first heat transfer layer is on the first resin layer on the side opposite from the carbon nanotubes and has a thermal conductivity higher than the thermal conductivity of the first resin layer. The second heat transfer layer is on the second resin layer on the side opposite from the carbon nanotubes and has a thermal conductivity higher than the thermal conductivity of the second resin layer. The carbon nanotubes have respective first end portions embedded in first resin constituting the first resin layer and have respective second end portions embedded in second resin constituting the second resin layer.

### CROSS-REFERENCE TO RELATED APPLICATION

This application is based upon and claims priority to Japanese Patent Application No. 2022-086985, filed on May 27, 2022, the entire contents of which are incorporated herein by reference.

### FIELD

A certain aspect of the embodiment discussed herein is related to heat conductors.

### BACKGROUND

A laminate using carbon nanotubes (CNTs) is known. According to this laminate, the carbon nanotubes are sandwiched vertically between protection materials (see, for example, International Publication Pamphlet No. WO 2016/158496).

Carbon nanotubes have good thermal conductance. Therefore, some laminates including carbon nanotubes are used as heat conductors. Carbon nanotubes, however, easily fall apart. Therefore, it is difficult to make carbon nanotubes into sheet form. Furthermore, the heat dissipation of a laminate including carbon nanotubes may be insufficient depending on the configuration of the laminate.

### SUMMARY

According to an embodiment, a heat conductor includes a first resin layer and a second resin layer each free of a filler, multiple carbon nanotubes extending between the first resin layer and the second resin layer, a first heat transfer layer, and a second heat transfer layer. The first heat transfer layer is on the first resin layer on the side opposite from the carbon nanotubes and has a thermal conductivity higher than the thermal conductivity of the first resin layer. The second heat transfer layer is on the second resin layer on the side opposite from the carbon nanotubes and has a thermal conductivity higher than the thermal conductivity of the second resin layer. The carbon nanotubes have respective first end portions embedded in first resin constituting the first resin layer and have respective second end portions embedded in second resin constituting the second resin layer.

The object and advantages of the invention will be realized and attained by means of the elements and combinations particularly pointed out in the claims.

It is to be understood that both the foregoing general description and the following detailed description are exemplary and explanatory and not restrictive of the invention, as claimed.

### BRIEF DESCRIPTION OF DRAWINGS

FIG. 1 is a perspective view of a heat conductor according to an embodiment;

FIGS. 2A and 2B are sectional views of the heat conductor according to the embodiment;

FIGS. 3A and 3B are scanning electron microscope (SEM) photographs of a section of the heat conductor according to the embodiment;

FIGS. 4A and 4B are sectional views of a heat conductor according to a comparative example;

FIGS. 5A through 5G are diagrams illustrating a process of manufacturing a heat conductor according to the embodiment;

FIG. 6 is a sectional view of a heat conductor according to a variation of the embodiment; and

FIG. 7 illustrates the result of evaluating the thermal conductivities, etc., of heat conductors.

### DESCRIPTION OF EMBODIMENTS

According to an embodiment, a heat conduction member (hereinafter “heat conductor”) that can be in sheet form and has good heat dissipation is provided.

One or more embodiments of the present invention are explained below with reference to the accompanying drawings. In the following description, the same elements or components are referred to using the same reference numeral, and a duplicate description thereof may be omitted.

### [Heat Conductor Structure]

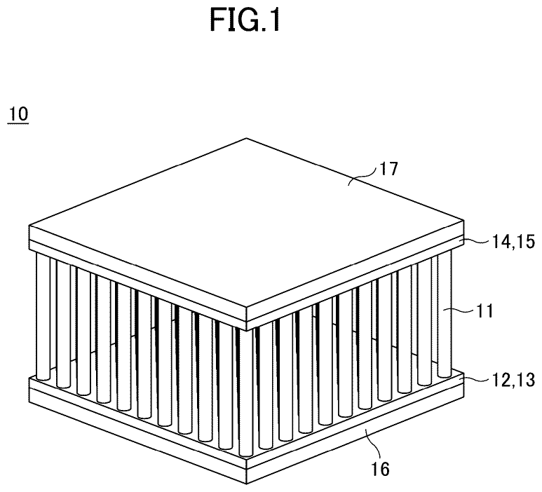

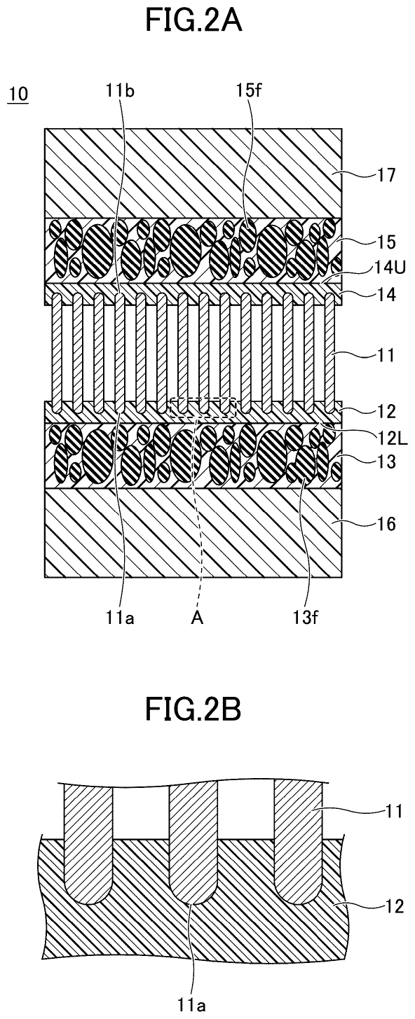

FIG. 1 is a perspective view of a heat conductor 10 according to an embodiment. FIG. 2A is a sectional view of the heat conductor 10. FIG. 2B is an enlarged view of part A of FIG. 2A.

Referring to FIGS. 1, 2A and 2B, the heat conductor 10 includes multiple carbon nanotubes 11, a first resin layer 12, a first heat transfer layer 13, a second resin layer 14, and a second heat transfer layer 15. The heat conductor 10 may further include protective layers 16 and 17. The heat conductor 10, which is a so-called “thermal interface material (TIM),” is a member placed between two members to transfer heat between the two members. For example, one of the two members is a heat generator and the other of the two members is a heat dissipator.

The carbon nanotubes 11 are disposed between the first resin layer 12 and the second resin layer 14 to extend substantially in a heat transfer direction. Here, the heat transfer direction is a direction substantially perpendicular to the upper surface of the first heat transfer layer 13 and the lower surface of the second heat transfer layer 15. The carbon nanotubes 11 may be regularly or irregularly spaced. Among the carbon nanotubes 11, adjacent carbon nanotubes may contact, but preferably, there is an airgap between adjacent carbon nanotubes. This improves the shrinkability of the carbon nanotubes 11 to enable the carbon nanotubes 11 to easily expand and shrink.

The carbon nanotubes 11 are carbon crystals having a substantially cylindrical (tubular) shape of, for example, approximately 0.7 nm to approximately 70 nm in diameter. The carbon nanotubes 11 are, for example, 50 μm or more and 300 μm or less in length. The carbon nanotubes 11 are highly heat-conductive, having a thermal conductivity of, for example, approximately 3000 W/m·K. To have good heat transfer performance, the carbon nanotubes 11 preferably have an area density of 1×10¹⁰ CNTs/cm² or more.

Each carbon nanotube 11 has first and second tips 11a and 11b at opposite ends. The first resin layer 12 is provided on an end portion of each carbon nanotube 11 extending from its first tip 11a (hereinafter “first end portion”). The first tip 11a defines an end point of the first end portion facing toward the first heat transfer layer 13, which is stacked on, that is, in contact with, a lower surface 12L of the first resin layer 12 on the opposite side from the carbon nanotubes 11. The resin constituting the first resin layer 12 fills in spaces (gaps) between the first end portions of the carbon nanotubes 11. In other words, the first end portions of the carbon nanotubes 11 are embedded in the first resin layer 12.

The length of the first end portion of each carbon nanotube 11, namely, the length of a portion of each carbon nanotube 11 embedded in the first resin layer 12, is, for example, 0.1 μm or more and 10 μm or less. The position of the first tip 11a may vary from carbon nanotube 11 to carbon nanotube 11.

Each carbon nanotube 11 does not protrude from the lower surface 12L of the first resin layer 12 at its first tip 11a. That is, the first tip 11a of each carbon nanotube 11 is positioned in the first resin layer 12 at a distance from the lower surface 12L, so that there is a region formed only of resin and free of the carbon nanotubes 11 between the first tips 11a of the carbon nanotubes 11 and the lower surface 12L in the first resin layer 12. Alternatively, however, one or more of the carbon nanotubes 11 may reach the lower surface 12L of the first resin layer 12 at their first tips 11a or protrude from the lower surface 12L.

The second resin layer 14 is provided on an end portion of each carbon nanotube 11 extending from its second tip 11b (hereinafter “second end portion”). The second tip 11b defines an end point of the second end portion facing toward the second heat transfer layer 15, which is stacked on, that is, in contact with, an upper surface 14U of the second resin layer 14 on the opposite side from the carbon nanotubes 11. The resin constituting the second resin layer 14 fills in spaces (gaps) between the second end portions of the carbon nanotubes 11. In other words, the second end portions of the carbon nanotubes 11 are embedded in the second resin layer 14.

The length of the second end portion of each carbon nanotube 11, namely, the length of a portion of each carbon nanotube 11 embedded in the second resin layer 14, is, for example, 0.1 μm or more and 10 μm or less. The position of the second tip 11b may vary from carbon nanotube 11 to carbon nanotube 11.

Each carbon nanotube 11 does not protrude from the upper surface 14U of the second resin layer 14 at its second tip 11b. That is, the second tip 11b of each carbon nanotube 11 is positioned in the second resin layer 14 at a distance from the upper surface 14U, so that there is a region formed only of resin and free of the carbon nanotubes 11 between the second tips 11b of the carbon nanotubes 11 and the upper surface 14U in the second resin layer 14. Alternatively, however, one or more of the carbon nanotubes 11 may reach the upper surface 14U of the second resin layer 14 at their second tips 11b or protrude from the upper surface 14U.

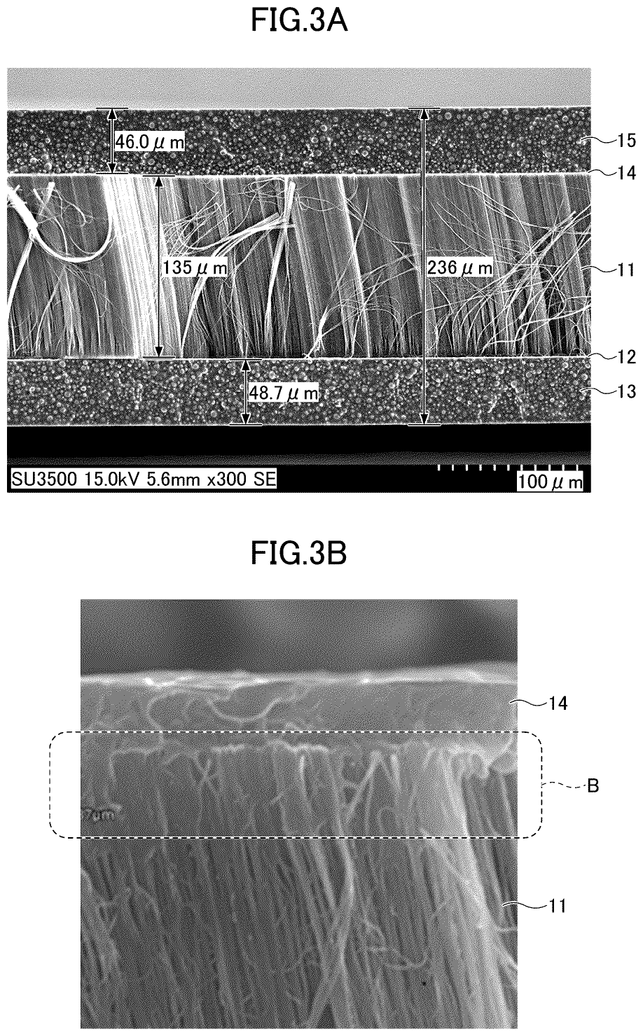

FIG. 3A is a scanning electron microscope (SEM) photograph of a section of the heat conductor 10 according to the embodiment. FIG. 3B is an enlarged view of part of FIG. 3A. It can be seen that the second end portions of the carbon nanotubes 11 are embedded in the resin of the second resin layer 14 in the part of FIG. 3B surrounded by the dashed line B.

Referring back to FIGS. 1, 2A and 2B, each of the first resin layer 12 and the second resin layer 14 includes no filler. In contrast, the first heat transfer layer 13 is a resin layer that includes a filler 13f. The first heat transfer layer 13 has a higher thermal conductivity than the first resin layer 12. Furthermore, the second heat transfer layer 15 is a resin layer that includes a filler 15f. The second heat transfer layer 15 has a higher thermal conductivity than the second resin layer 14. Examples of the fillers 13f and 15f include alumina and aluminum nitride. The fillers 13f and 15f may be, for example, approximately 0.1 μm to approximately 10 μm in diameter. Each of the first resin layer 12 and the second resin layer 14 has a thermal conductivity of, for example, approximately 0.1 W/m·K to approximately 0.3 W/m·K. In contrast, each of the first heat transfer layer 13 and the second heat transfer layer 15 has a thermal conductivity of, for example, approximately 1 W/m·K to approximately 15 W/m·K.

Each of the first resin layer 12 and the second resin layer 14 may be formed of, for example, polyphenylene ether resin. The resin layers constituting the first heat transfer layer 13 and the second heat transfer layer 15 may be formed of, for example, polyphenylene ether resin. The resin layers constituting the first heat transfer layer 13 and the second heat transfer layer 15 may be formed of resin different from the resin of the first resin layer 12 and the second resin layer 14.

Preferably, the first resin layer 12 is thinner than the first heat transfer layer 13 and the second resin layer 14 is thinner than the second heat transfer layer 15. The thickness of each of the first resin layer 12 and the second resin layer 14 may be, for example, 1 μm or more and 30 μm or less. The thickness of each of the first resin layer 12 and the second resin layer 14 is preferably 1 μm or more and 10 μm or less and is more preferably 0.1 μm or more and 5 μm or less. The thickness of each of the first heat transfer layer 13 and the second heat transfer layer 15 may be, for example, approximately 50 μm to approximately 250 μm.

The first resin layer 12 has a lower thermal conductivity than the first heat transfer layer 13 and the second resin layer 14 has a lower thermal conductivity than the second heat transfer layer 15. If the thickness of each of the first resin layer 12 and the second resin layer 14 is 1 μm or more and 30 μm or less, however, the thermal resistance of each of the first resin layer 12 and the second resin layer 14 can be kept low, and a decrease in the thermal conductivity of the heat conductor 10 as a whole can be suppressed. If the thickness of each of the first resin layer 12 and the second resin layer 14 is 1 μm or more and 10 μm or less, a decrease in the thermal conductivity of the heat conductor 10 as a whole can be further suppressed. If the thickness of each of the first resin layer 12 and the second resin layer 14 is 0.1 μm or more and 5 μm or less, a decrease in the thermal conductivity of the heat conductor 10 as a whole can be even further suppressed.

The protective layer 16 is stacked on a surface of the first heat transfer layer 13 on the opposite side from the first resin layer 12 on an as-needed basis to protect the first heat transfer layer 13. The protective layer 17 is stacked on a surface of the second heat transfer layer 15 on the opposite side from the second resin layer 14 on an as-needed basis to protect the second heat transfer layer 15. Each of the protective layers 16 and 17 is a member in film form and is removed when the heat conductor 10 is used. Examples of the protective layers 16 and 17 include polyethylene terephthalate films.

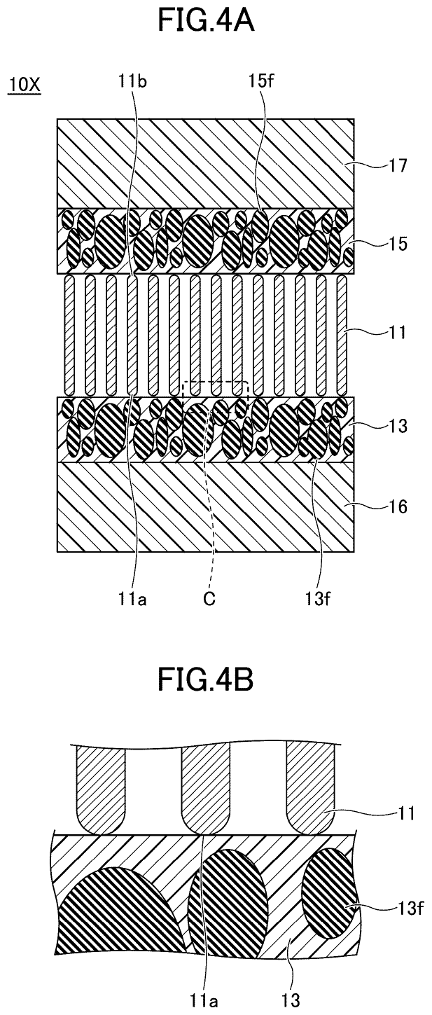

FIG. 4A is a sectional view of a heat conductor 10X according to a comparative example. FIG. 4B is an enlarged view of part C of FIG. 4A.

Referring to FIGS. 4A and 4B, the heat conductor 10X according to the comparative example is different from the heat conductor 10 of the embodiment (see, for example, FIGS. 2A and 2B) in not having the first resin layer 12 and the second resin layer 14.

In the heat conductor 10X, the filler 13f included in the first heat transfer layer 13 hinders the first end portions of the carbon nanotubes 11 from being embedded into the resin of the first heat transfer layer 13. Therefore, the first end portions of the carbon nanotubes 11 are not at all or hardly embedded in the resin of the first heat transfer layer 13. Furthermore, the filler 15f included in the second heat transfer layer 15 hinders the second end portions of the carbon nanotubes 11 from being embedded into the resin of the second heat transfer layer 15. Therefore, the second end portions of the carbon nanotubes 11 are not at all or hardly embedded in the resin of the second heat transfer layer 15.

As a result, in the heat conductor 10X, the carbon nanotubes 11 fall apart to be unable to maintain the shape illustrated in FIG. 4A and thus cannot be made into sheet form. Here, removing the fillers 13f and 15f from the first heat transfer layer 13 and the second heat transfer layer 15, respectively, would allow the first end portions and the second end portions of the carbon nanotubes 11 to be embedded into the resin of the first heat transfer layer 13 and the second heat transfer layer 15, so that it would be possible to make the carbon nanotubes 11 into sheet form. In this case, however, removing the fillers 13f and 15f from the first heat transfer layer 13 and the second heat transfer layer 15, respectively, would decrease the thermal conductivities of the first heat transfer layer 13 and the second heat transfer layer 15, thus preventing the heat conductor 10X from delivering sufficient heat dissipation performance.

In contrast, according to the heat conductor 10, the first resin layer 12 including no filler is placed on the first end portions of the carbon nanotubes 11, and the second resin layer 14 including no filler is placed on the second end portions of the carbon nanotubes 11. This allows the first end portions and the second end portions of the carbon nanotubes 11 to be embedded into the resin of the first resin layer 12 and the second resin layer 14 to make it possible to make the carbon nanotubes 11 into sheet form. Furthermore, the thickness of each of the first resin layer 12 and the second resin layer 14 is reduced to the extent that the heat dissipation of the heat conductor 10 is not affected, and the first heat transfer layer 13 having good thermal conductivity is stacked on the first resin layer 12 and the second heat transfer layer 15 having good thermal conductivity is stacked on the second resin layer 14. As a result, the heat conductor 10 can be made into sheet form and has good heat dissipation. The heat conductor 10 may have a thermal conductivity of, for example, approximately 20 W/m·K to approximately 30 W/m·K.

Furthermore, it is supposed that a heat conductor has no carbon nanotubes and is formed only of a less flexible, hard material such as solder or sintered material. In this case, if the heat conductor is interposed between a heat generator and a heat dissipator, a difference in the coefficient of thermal expansion between these members may cause warpage or delamination in the heat conductor during thermal loading. In contrast, according to the heat conductor 10, the carbon nanotubes 11 having good flexibility are placed in the center in the thickness direction. Therefore, when the heat conductor 10 is placed between a heat generator and a heat dissipator, stress resulting from a difference in the coefficient of thermal expansion between these members is reduced by the carbon nanotubes 11. As a result, it is possible to reduce the possibility of generation of warpage or delamination in the heat conductor 10 during thermal loading. While the elastic modulus of solder is approximately 40 GPa, the elastic modulus of the heat conductor 10 including the carbon nanotubes 11 is 5 GPa or less.

### [Method of Manufacturing Heat Conductor]

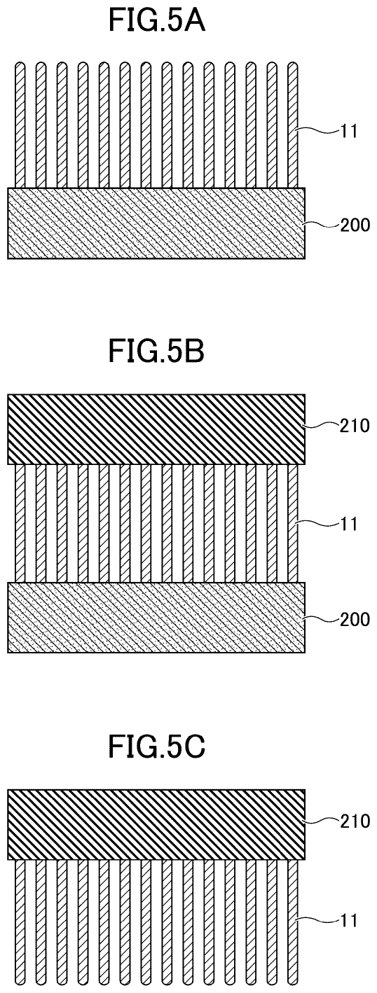

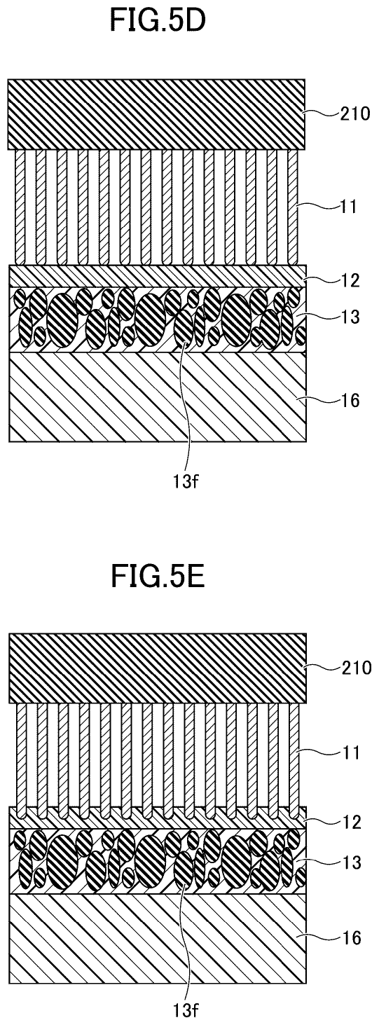

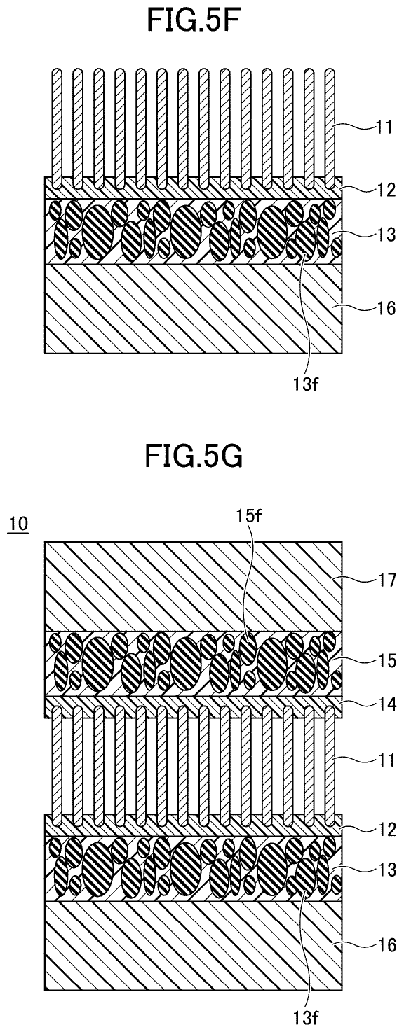

Next, a method of manufacturing a heat conductor according to the embodiment is described. FIGS. 5A through 5G are diagrams illustrating a process of manufacturing a heat conductor according to the embodiment.

First, in the process illustrated in FIG. 5A, a substrate 200 is prepared, and the carbon nanotubes 11 are formed on the upper surface of the substrate 200. Examples of the substrate 200 include a plate of silicon (Si), copper (Cu) or the like.

More specifically, a metal catalyst layer is formed on the upper surface of the substrate 200 by, for example, sputtering. For example, iron (Fe), cobalt (Co), aluminum (Al), nickel (Ni) or the like may be used for the metal catalyst layer. The thickness of the metal catalyst layer may be, for example, approximately several nanometers. Next, the substrate 200 on which the metal catalyst layer is formed is put into a furnace, and chemical vapor deposition (CVD) is used to form the carbon nanotubes 11 on the metal catalyst layer at a predetermined pressure and temperature using a process gas. The pressure and the temperature of the furnace may be, for example, 0.1 kPa to 8.0 kPa and 500° C. to 800° C., respectively. Examples of process gases include acetylene gas, and examples of carrier gases include argon gas and hydrogen gas.

Next, in the process illustrated in FIG. 5B, a transfer member 210 is caused to contact the upper end portions of the carbon nanotubes 11 grown on the substrate 200, and is pressed toward the substrate 200. Examples of the transfer member 210 include a silicon rubber sheet. Next, in the process illustrated in FIG. 5C, the substrate 200 illustrated in FIG. 5B is removed. As a result, the carbon nanotubes 11 are transferred to the transfer member 210.

Next, in the process illustrated in FIG. 5D, a laminate of the protective layer 16, the first heat transfer layer 13, and the first resin layer 12 is prepared, and the transfer member 210 to which the carbon nanotubes 11 are transferred is oriented such that the carbon nanotubes 11 face the first resin layer 12. For example, a film of thermosetting polyphenylene ether resin may be used as the first resin layer 12. The first resin layer 12 contains no filler. For example, a film of thermosetting polyphenylene ether resin may be used as the first heat transfer layer 13. The first heat transfer layer 13 contains the filler 13f. For example, a polyethylene terephthalate film or the like may be used as the protective layer 16.

Next, in the process illustrated in FIG. 5E, the transfer member 210 is pressed toward the first resin layer 12 while heating the structure illustrated in FIG. 5D. As a result, the first resin layer 12 softens, so that the first end portions of the carbon nanotubes 11 are embedded into the resin of the first resin layer 12.

Next, in the process illustrated in FIG. 5F, the transfer member 210 illustrated in FIG. 5E is removed from the carbon nanotubes 11. During heating in the process illustrated in FIG. 5E, heat is also transferred to the transfer member 210 to soften the transfer member 210. Therefore, the transfer member 210 can be easily removed from the carbon nanotubes 11.

Next, in the process illustrated in FIG. 5G, a laminate of the protective layer 17, the second heat transfer layer 15, and the second resin layer 14 is prepared. The second resin layer 14 is oriented toward the carbon nanotubes 11 and is pressed toward the first resin layer 12 while being heated. As a result, the second resin layer 14 softens, so that the second end portions of the carbon nanotubes 11 are embedded into the resin of the second resin layer 14. For example, a film of thermosetting polyphenylene ether resin may be used as the second resin layer 14. The second resin layer 14 contains no filler. For example, a film of thermosetting polyphenylene ether resin may be used as the second heat transfer layer 15. The second heat transfer layer 15 contains the filler 15f. For example, a polyethylene terephthalate film or the like may be used as the protective layer 17. Through the above-noted process, the heat conductor 10 is completed.

### VARIATION OF EMBODIMENT

A heat conductor according to a variation of the embodiment uses a material other than resin containing a filler for the first heat transfer layer and the second heat transfer layer. In the following description of the variation, a description of the same elements or components as those of the above-described embodiment may be omitted.

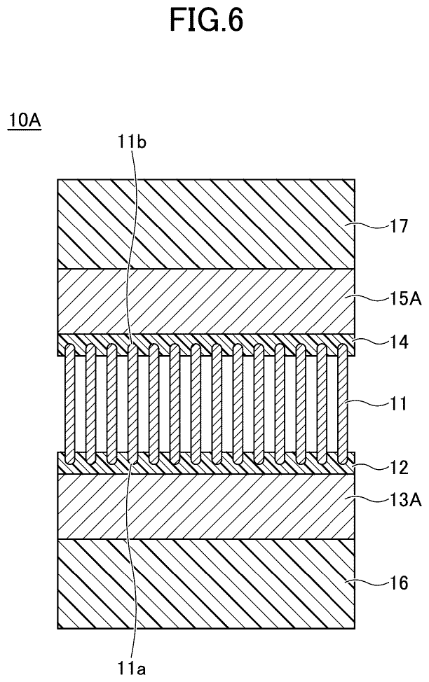

FIG. 6 is a sectional view of a heat conductor 10A according to the variation. Referring to FIG. 6, the heat conductor 10A according to the variation is different from the heat conductor 10 of the embodiment (see, for example, FIGS. 2A and 2B) in that a first heat transfer layer 13A and a second heat transfer layer 15A replace the first heat transfer layer 13 and the second heat transfer layer 15, respectively.

According to the heat conductor 10A, the first heat transfer layer 13A and the second heat transfer layer 15A are formed of solder. Examples of solder forming the first heat transfer layer 13A and the second heat transfer layer 15A include tin (Sn)-based solder.

Thus, the first heat transfer layer and the second heat transfer layer are not limited to those formed of resin containing a filler, and may be formed using various materials having good heat dissipation. The first heat transfer layer and the second heat transfer layer may also be formed of indium or sintered material. In this case as well, good heat dissipation can be achieved.

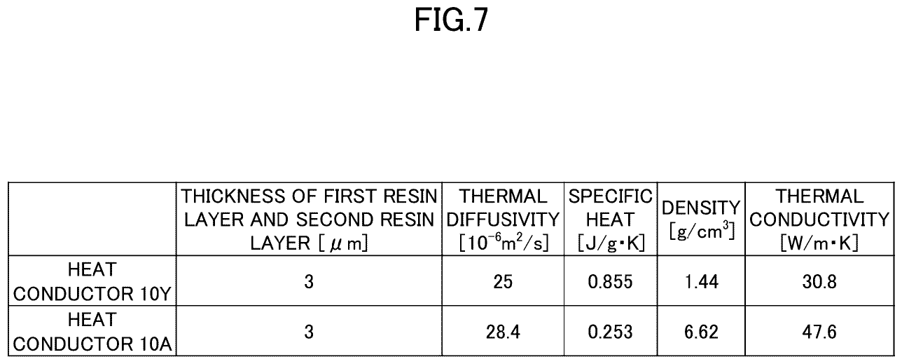

FIG. 7 illustrates the results of evaluating the thermal conductivity, etc., of heat conductors. Specifically, with respect to a heat conductor that does not include the first heat transfer layer and the second heat transfer layer and includes only the first resin layer and the second resin layer (hereinafter “heat conductor 10Y” for convenience) and the heat conductor 10A that uses solder for the first heat transfer layer and the second heat transfer layer, thermal diffusivity, specific heat, and density were measured to calculate thermal conductivity. Here, thermal conductivity=thermal diffusivity×specific heat×density.

In the heat conductors 10Y and 10A, the thickness of each of the first resin layer and the second resin layer is 3 μm. Furthermore, in the heat conductor 10A, the thickness of each of the first heat transfer layer and the second heat transfer layer is 250 μm. The thermal diffusivity was measured using Thermowave Analyzer TA35 manufactured by Bethel Co., Ltd. The specific heat was measured using DSC 200 F3 Maia manufactured by NETZSCH. The density was measured using Ultrapycnometer 1000M-UPYC manufactured by QUANTACHROME INSTRUMENTS.

As illustrated in FIG. 7, it has been found that the heat conductor 10Y can achieve a thermal conductivity of 30.8 W/m·K. Furthermore, it has been found that the heat conductor 10A, which uses solder for the first heat transfer layer and the second heat transfer layer, can achieve a good thermal conductivity of 47.6 W/m·K, which is approximately 1.5 times the thermal conductivity achieved by the heat conductor 10Y.

Further improvement in thermal conductivity can be expected by using material that is more heat-conductive than solder, such as sintered material, indium or the like, for the first heat transfer layer and the second heat transfer layer.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority or inferiority of the invention. Although one or more embodiments of the present invention have been described in detail, it should be understood that the various changes, substitutions, and alterations could be made hereto without departing from the spirit and scope of the invention.

What is claimed is:

1. A heat conductor comprising:
a first resin layer free of a filler;
a second resin layer free of a filler;
a plurality of carbon nanotubes extending between the first resin layer and the second resin layer;
a first heat transfer layer on the first resin layer on a side opposite from the plurality of carbon nanotubes, the first heat transfer layer having a thermal conductivity higher than a thermal conductivity of the first resin layer; and
a second heat transfer layer on the second resin layer on a side opposite from the plurality of carbon nanotubes, the second heat transfer layer having a thermal conductivity higher than a thermal conductivity of the second resin layer,
wherein the plurality of carbon nanotubes have respective first end portions embedded in first resin constituting the first resin layer and have respective second end portions embedded in second resin constituting the second resin layer.

2. The heat conductor as claimed in claim 1, wherein
the first resin layer includes a first region consisting of the first resin and free of the plurality of carbon nanotubes, the first region being between respective first tips of the plurality of carbon nanotubes and a surface of the first resin layer contacting the first heat transfer layer, the first tips facing toward the first heat transfer layer, and
the second resin layer includes a second region consisting of the second resin and free of the plurality of carbon nanotubes, the second region being between respective second tips of the plurality of carbon nanotubes and a surface of the second resin layer contacting the second heat transfer layer, the second tips facing toward the second heat transfer layer.

3. The heat conductor as claimed in claim 1, wherein
the first resin layer is thinner than the first heat transfer layer, and
the second resin layer is thinner than the second heat transfer layer.

4. The heat conductor as claimed in claim 1, wherein the first resin layer or the second resin layer is formed of polyphenylene ether resin.

5. The heat conductor as claimed in claim 1, wherein each of the first heat transfer layer and the second heat transfer layer is a resin layer containing a filler.

6. The heat conductor as claimed in claim 5, wherein the resin layer is formed of polyphenylene ether resin.

7. The heat conductor as claimed in claim 1, wherein the first heat transfer layer and the second heat transfer layer are formed of solder.

8. The heat conductor as claimed in claim 1, wherein the first heat transfer layer and the second heat transfer layer are formed of indium.

9. The heat conductor as claimed in claim 1, wherein the first heat transfer layer and the second heat transfer layer are formed of a sintered material.

10. The heat conductor as claimed in claim 1, further comprising:
a first protective layer on a surface of the first heat transfer layer on an opposite side from the first resin layer; and
a second protective layer on a surface of the second heat transfer layer on an opposite side from the second resin layer.

11. The heat conductor as claimed in claim 1, wherein each of the first resin layer and the second resin layer has a thickness of 1 μm or more and 30 μm or less.
